(19) United States
(12) Patent Application Publication
(10) Pub. No.: US 2014/0375831 A1
(43) Pub. Date: Dec. 25, 2014

(54) IMAGING DEVICE, IMAGING CONDITION SETTING METHOD, AND STORAGE MEDIUM

(71) Applicant: CASIO COMPUTER CO., LTD., Tokyo (JP)

(72) Inventor: Yoshiyuki KATO, Tokyo (JP)

(73) Assignee: CASIO COMPUTER CO., LTD., Tokyo (JP)

(21) Appl. No.: 14/293,698

(22) Filed: Jun. 2, 2014

(30) Foreign Application Priority Data
Jun. 21, 2013 (JP) 2013-130190

(51) Int. Cl. H04N 5/232

(52) U.S. Cl. CPC H04N 5/23206
USPC 348/211.2

(57) ABSTRACT

A digital camera of the present invention constructs pairing (wireless connection recognition) with an information terminal such as a smartphone or tablet terminal and a pairing device such as a Bluetooth key, by using wireless communications usable by the respective devices. When pairing with the pairing device is established, the digital camera reads photographing conditions according to the paired pairing device from a photographing conditions table, and sets the photographing conditions as an imaging condition of the digital camera. The information terminal and the pairing device such as the Bluetooth key perform a remote operation on the digital camera via the respective wireless communications, by using an application (program) dedicated for camera operation started in the respective devices.

### CROSS-REFERENCE TO RELATED APPLICATION

This application is based upon and claims the benefit of priority from the prior Japanese Patent Application No. 2013-130190, filed Jun. 21, 2013, the entire contents of which are incorporated herein by reference.

### BACKGROUND OF THE INVENTION

1. Field of the Invention

The present invention relates to an imaging device, imaging condition setting method, and a storage medium.

2. Description of the Related Art

In recent years, a technology of connecting (pairing) a digital camera with a pairing device such as a smartphone, tablet terminal and remote controller (Bluetooth key) via a wireless LAN (WiFi) or Bluetooth (registered trademark) has been known. The pairing device can perform a remote operation (such as starting and stopping imaging, setting an operation mode, zooming, setting an imaging condition, and viewing a captured image (captured moving image)) on the digital camera.

Meanwhile, as described above, examples of the pairing device include a smartphone, tablet terminal, and remote controller (Bluetooth key), but display capability (such as display size and resolution) and operation environment vary among these pairing devices. Accordingly, settings according to the display capability and operability have to be made on a digital camera side for each pairing device. However, digital cameras in recent years are multifunctional and have many items to be set, and setting and changing items for each pairing device is burdensome.

To address this, as described in Japanese Patent Application Laid-Open (Kokai) Publication No. 2005-347933, for example, a technology of changing an imaging condition according to the communication environment of a communication counterpart has been suggested. This conventional art discloses a technology of setting an imaging condition according to the communication environment (such as the degree of the communication speed) of a communication counterpart to which an image is to be sent, by referring imaging conditions set and registered in advance.

### SUMMARY OF THE INVENTION

In accordance with one aspect of the present invention, there is provided an imaging device comprising: an imaging section; a connecting section which connects to a counterpart; a setting section which specifies the counterpart connected by the connecting section and sets an imaging condition according to the specified counterpart; and a control section which controls the imaging section such that imaging is performed under the imaging condition set by the setting section.

In accordance with another aspect of the present invention, there is provided an imaging condition setting method for an imaging device including an imaging section, the method comprising: a connecting step of connecting to a counterpart; a setting step of specifying the connected counterpart and setting an imaging condition according to the specified counterpart; and a control step of controlling the imaging section such that imaging is performed under the set imaging condition.

In accordance with another aspect of the present invention, there is provided a non-transitory computer-readable storage medium having stored thereon a program that is executable by a computer of an imaging device including an imaging section to perform functions comprising: connection processing for connecting to a counterpart; setting processing for specifying the counterpart connected by the connection processing and setting an imaging condition according to the specified counterpart; and control processing for controlling the imaging section such that imaging is performed under the imaging condition set in the setting processing.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 is a block diagram of the structure of a communication system using a digital camera 10 according to an embodiment of the present invention;

FIG. 2 is a block diagram of the structure of the digital camera 10 according to the present embodiment;

FIG. 3 is a conceptual diagram of a photographing conditions table of the digital camera 10 according to the present embodiment;

FIG. 4 is a flowchart for describing the operation (at the case of pairing) of the digital camera 10 according to the present embodiment; and

FIG. 5 is a flowchart for describing the operation (at the timing of turning power supply OFF) of the digital camera 10 according to the present embodiment.

### DETAILED DESCRIPTION OF THE PREFERRED EMBODIMENTS

An embodiment of the present invention will hereinafter be described with reference to the drawings.

A. Structure of Embodiment

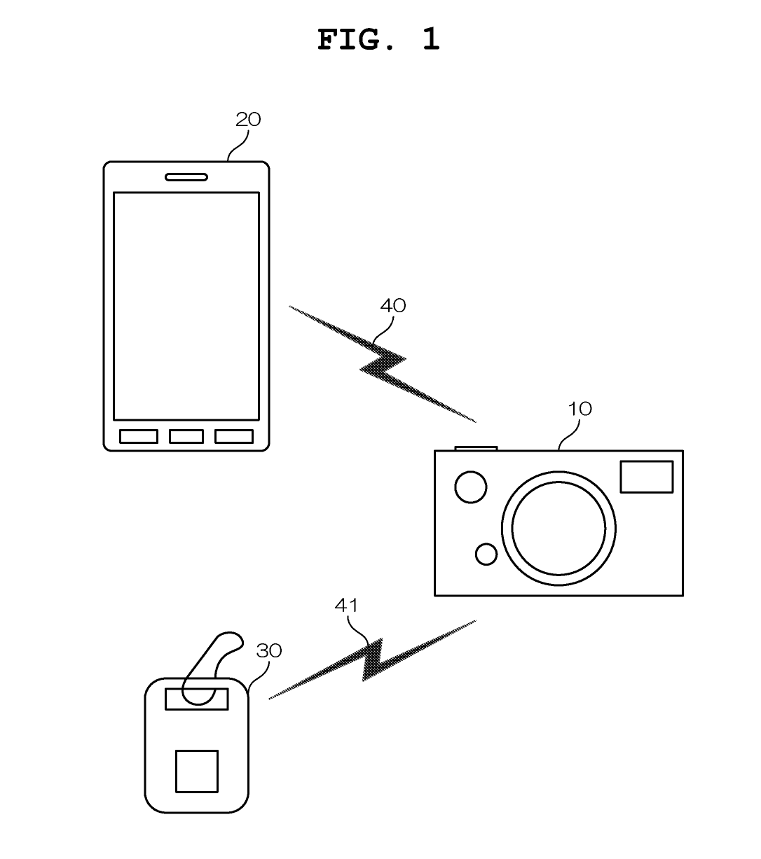

FIG. 1 is a block diagram of the structure of a communication system using a digital camera 10 according to an embodiment of the present invention. In FIG. 1, the digital camera 10 constructs pairing (wireless connection recognition) with an information terminal 20 such as a smartphone and tablet terminal, and a Bluetooth key 30 by using wireless communications 40 and 41 usable by the respective devices. The information terminal 20 and the Bluetooth key 30 perform a remote operation on the digital camera 10 via the wireless communications 40 and 41, respectively, each by using an application (program) dedicated for camera operation started in each device.

The remote operation in the present invention includes operations of starting and stopping imaging, setting an operation mode, zooming, setting an imaging condition, and viewing a captured image (captured moving image). Also in FIG. 1, the wireless communication 40 is a wireless LAN (WiFi), and the wireless communication 41 is Bluetooth (registered trademark). Furthermore, the digital camera 10 depicted in FIG. 1 has a general shape so as to be gripped by the user or mounted on a tripod or the like for imaging. However, this is not meant to be restrictive, and the digital camera 10 may have a shape so as to be mounted on the human body, or may have an imaging section and a control section separately provided and connected to each other via a cable or the like.

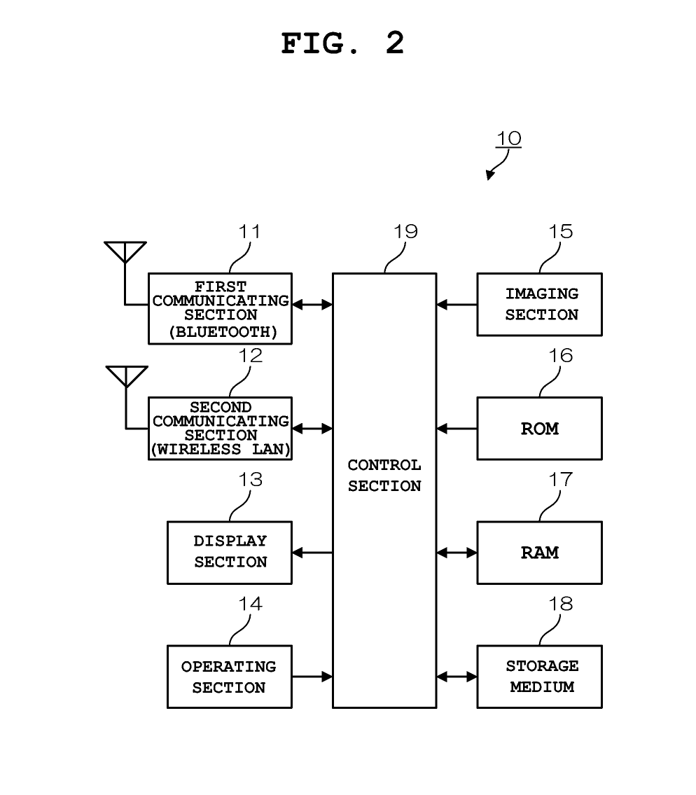

FIG. 2 is a block diagram of the structure of the digital camera 10 according to the present embodiment. The digital camera 10 includes a first communicating section (Bluetooth (registered trademark)) 11, a second communicating section (wireless LAN) 12, a display section 13, an operating section 14, an imaging section 15, a ROM (Read Only Memory) 16, a RAM (Random Access Memory) 17, a storage medium 18, and a control section 19.

The first communicating section 11 transmits and receives a command for remote operation and image data, etc. to and from the Bluetooth key 30 by using Bluetooth (registered trademark). The second communicating section 12 transmits and receives a command for remote operation and image data, etc. to and from the information terminal 20 by using the wireless LAN.

The display section 13 is made up of a liquid-crystal display device and an organic EL (Electro Luminescence) display device, etc., and displays various menu screens, a live view screen at the timing of imaging, and the playback of the captured image data, etc. The operating section 14 includes a plurality of operation keys such as a shutter switch, a zoom switch, a mode key, a SET key, and a cross key, and outputs an operation signal according to the key operation by the user. The imaging section 15 includes a lens block formed of an optical lens group and an image sensor such as a CCD (Charge-Coupled Device) or CMOS (Complementary Metal-Oxide Semiconductor), and outputs a digital signal by that the image sensor converts an usage entering from the lens block to the digital signal.

The ROM 16 stores a program to be executed by the control section 19, which will be described further below, and various parameters required for operations, etc. The RAM 17 is used as a buffer memory for temporarily storing image data captured by the imaging section 15, and is also used as a working memory for the control section 19. The storage medium 18 stores captured image data, etc.

The control section 19 controls the operation of each section by executing the program stored in the ROM 16 described above. In particular, in the present embodiment, when pairing with the pairing device is established, the control section 19 refers to a photographing conditions table, which will be described further below, and reads photographing conditions according to the paired pairing device and sets the read photographing conditions as an imaging condition of the digital camera 10. As a result, various imaging conditions can be switched only by pairing. Even if the digital camera 10 pairs with various pairing devices an imaging condition according to each pairing device can be easily set, thereby preventing user's operation from being complicated.

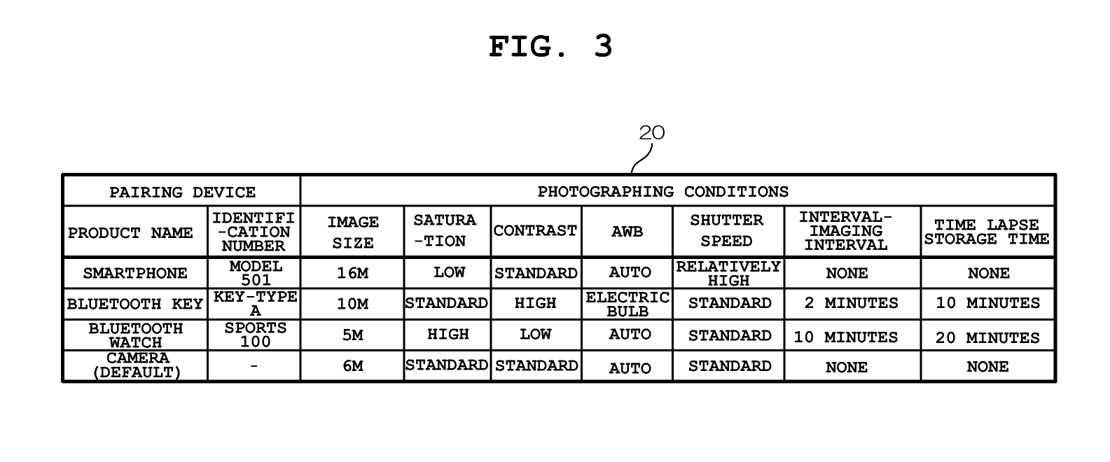

FIG. 3 is a conceptual diagram of a photographing conditions table 20 of the digital camera 10 according to the present embodiment. In the present embodiment, for each pairing device for pairing, the digital camera 10 retains photographing conditions to be set as an imaging condition of the digital camera 10 in the RAM 17 or the like as the photographing conditions table 20. As information about each pairing device, its product name and identification number are retained. With the product name and the identification number, the pairing device itself can be specified, and the communication capability of the pairing device can also be specified. Examples of the pairing device include a smartphone, Bluetooth key, and Bluetooth watch (wristwatch). Camera (default) indicates the case in which no pairing device is connected. As photographing conditions, image size, saturation, contrast, AWB (Auto White Balance), shutter speed, interval-imaging interval, and time lapse storage time, etc. are stored.

Note that the example depicted in FIG. 3 is merely an example, and another example is described below.

For example, in the case of a pairing device (in particular, smartphone) which can be paired not only via Bluetooth (registered trademark) but also a wireless LAN (WiFi), it is possible to view an image in the digital camera 10, receive the image from the digital camera 10, and upload the image to a network, etc. On the other hand, it is considered that a live view is checked not so often during mountain hiking, running, or the like. Accordingly, functions requiring time for the entire imaging processing, such as high image quality and continuous-image capturing/combining permissions, may be prioritized.

In the case of a pairing device (Bluetooth key) which has only a Bluetooth (registered trademark) function and furthermore cannot transfer live view video, there is a high possibility that the pairing device is used mainly as a remote controller. Accordingly, high image quality, face recognition ON, and a timer function may be prioritized.

Furthermore, when more movement than predetermined movement is known from the live view video or information from an acceleration sensor (not shown) included in the digital camera 10, the image quality may be degraded to medium image quality, and the continuous-image capturing/combining system except a high-speed continuous imaging system may be set as unusable.

On the other hand, when the imaging condition is changed to a camera-shake correction function and to an imaging condition resistant to blurring of the subject, interval still-image capturing and moving-image capturing may be performed. In this instance, it may be judged whether a short press or long press of a shutter trigger has been made on a pairing device side, and imaging may be switched to interval still-image capturing in the case of a short press and to moving-image capturing in the case of a long press (for supporting sports).

Still further, in the case of a device (Bluetooth watch) which has only with a Bluetooth (registered trademark) and can transfer live view video, it is considered that a live view is often checked during mountain hiking, running, or the like. In this case, the image quality may be degraded to low image quality, the imaging condition may be changed to a camera-shake correction function and to an imaging condition resistant to blurring of the subject, and imaging may be switched to interval moving-image capturing (face detection OFF)

B. Operation of Embodiment

Next, the operation of the above-described embodiment is described.

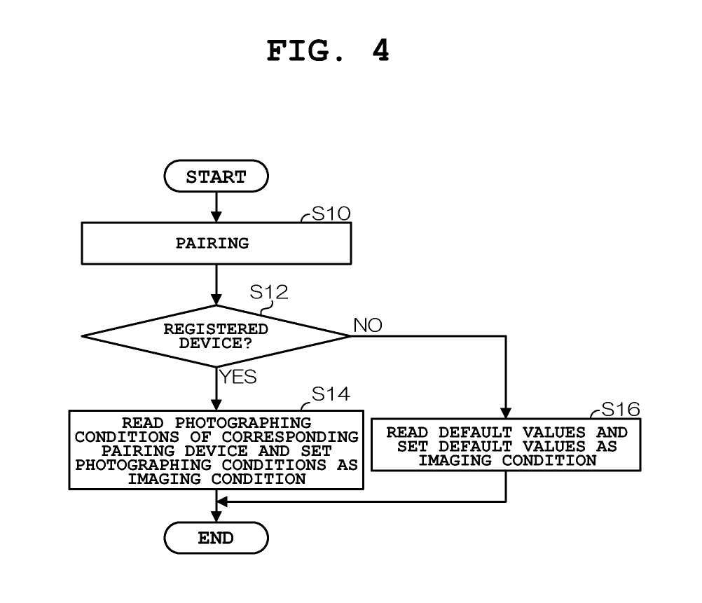

FIG. 4 is a flowchart for describing the operation (at the case of pairing) of the digital camera 10 according to the present embodiment. In the digital camera 10, the control section 19 performs pairing with the information terminal when the camera is started (Step S10). Next, the control section judges whether the paired information terminal is a registered device (Step S12). When the information terminal is a registered device (YES at Step S12), the control section 19 reads the photographing conditions of the corresponding information terminal from the photographing conditions table 20 depicted in FIG. 3 and sets the photographing conditions as an imaging condition (Step S14). On the other hand, when the information terminal is not a registered device (NO at Step S12), the control section 19 reads default values (camera (default)) and sets the default values as an imaging condition (Step S16).

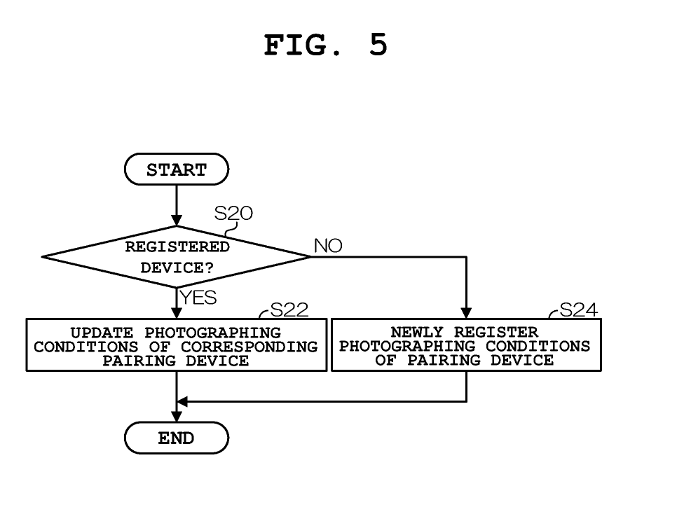

FIG. 5 is a flowchart for describing the operation (at the timing of turning power supply OFF) of the digital camera 10 according to the present embodiment. When the power supply OFF operation has been carried out in the digital camera 10, the control section 19 judges whether the information terminal that has been connected so far is a registered device (Step S20). When the information terminal is a registered device (YES at Step S20), the control section 19 updates the photographing conditions of the photographing conditions table 20 with the photographing condition of the corresponding pairing device (Step S22). On the other hand, when the information terminal is not a registered device (NO at Step S20), the control section 19 newly registers (adds) the photographing condition of the pairing device as photographing conditions of the photographing conditions table 20 (Step S24).

According to the above-described embodiment, when pairing with the pairing device is established, the photographing conditions according to the paired pairing device are set as an imaging condition of the digital camera 10. Accordingly, an imaging condition according to an operating condition of the pairing device (operating device) can be easily set.

Also, according to the above-described embodiment, an imaging condition is associated with a photographing condition of each pairing device (operating device) and the photographing condition is retained in the photographing conditions table 20. Accordingly, an imaging condition according to an operating condition of the pairing device (operating device) can be easily set.

Furthermore, according to the above-described embodiment, the paired pairing device (operating device) is specified with information unique to the terminal of the counterpart. Accordingly, the pairing device (operating device) can be easily and reliably specified.

Still further, according to the above-described embodiment, the communication capability of the paired pairing device (operating device) can be specified. Accordingly, an imaging condition according to an operating condition of the pairing device (operating device) can be easily set.

Still further, according to the above-described embodiment, the paired pairing device (operating device) is a device for operating the digital camera 10. Accordingly, an imaging condition according to an operating condition of the pairing device (operating device) can be easily set.

Still further, according to the above-described embodiment, when the pairing device (operating device) is a specific device owned by an individual, an imaging condition of the digital camera 10 can be set for each individual who owns a pairing device to be paired, and an imaging condition can be easily set according to each individual and use purpose.

While the present invention has been described with reference to the preferred embodiments, it is intended that the invention be not limited by any of the details of the description therein but includes all the embodiments which fall within the scope of the appended claims.

What is claimed is:

1. An imaging device comprising:
an imaging section;
a connecting section which connects to a counterpart;
a setting section which specifies the counterpart connected by the connecting section and sets an imaging condition according to the specified counterpart; and
a control section which controls the imaging section such that imaging is performed under the imaging condition set by the setting section.

2. The imaging device according to claim 1, further comprising a storage section which stores a plurality of imaging conditions each of which is associated with information for specifying each counterpart.

3. The imaging device according to claim 2, wherein the information for specifying the counterpart is information unique to a terminal owned by the counterpart.

4. The imaging device according to claim 2, wherein the information for specifying the counterpart is information for specifying communication capability of the terminal of the counterpart.

5. The imaging device according to claim 4, wherein the terminal of the counterpart is a device for operating the imaging device.

6. The imaging device according to claim 1,
wherein the connecting section includes a device which supports at least two types of communication schemes, and
wherein the setting section specifies the counterpart based on a communication scheme used by the connecting section when the connecting section connects to the counterpart.

7. An imaging condition setting method for an imaging device including an imaging section, the method comprising:
a connecting step of connecting to a counterpart;
a setting step of specifying the connected counterpart and setting an imaging condition according to the specified counterpart; and
a control step of controlling the imaging section such that imaging is performed under the set imaging condition.

8. A non-transitory computer-readable storage medium having stored thereon a program that is executable by a computer of an imaging device including an imaging section to perform functions comprising:
connection processing for connecting to a counterpart;
setting processing for specifying the counterpart connected by the connection processing and setting an imaging condition according to the specified counterpart; and
control processing for controlling the imaging section such that imaging is performed under the imaging condition set in the setting processing.
